(19) United States
(12) Patent Application Publication
(10) Pub. No.: US 2026/0305657 A1
(43) Pub. Date: Oct. 8, 2026

(54) MEAT CRUST AS FOOD ADDITIVE WITH ANTIOXIDANT ACTIVITY

(71) Applicant: YISSUM RESEARCH DEVELOPMENT COMPANY OF THE HEBREW UNIVERSITY OF JERUSALEM LTD., Jerusalem (IL)

(72) Inventors: Oren TIROSH, Rehovot (IL); Eylon ASIDO, Rehovot (IL); Joseph KANNER, Rehovot (IL)

(73) Assignee: YISSUM RESEARCH DEVELOPMENT COMPANY OF THE HEBREW UNIVERSITY OF JERUSALEM LTD., Jerusalem (IL)

(21) Appl. No.: 19/482,596

(22) PCT Filed: May 8, 2024
(86) PCT No.: PCT/IL2024/050442

§ 371 Date: Nov. 7, 2025

Related U.S. Application Data
(60) Provisional application No. 63/465,068, filed on May 9, 2023.

(51) Int. Cl. A23L 13/10; A23L 13/75; A23L 33/10

(52) U.S. Cl. CPC A23L 13/10; A23L 13/75; A23L 33/10

(57) ABSTRACT

A process for preparing a meat-derived antioxidant, comprising cooking or heat drying meat by direct contact with a hot surface to form a crust and comminuting an isolated form of the crust to obtain crust particles suitable for use as a food additive. The meat crust, and its use as a food additive antioxidant, are also provided by the invention.

### BACKGROUND OF THE INVENTION

Oxidative stress due to lipid peroxidation products in foods and postprandial oxidative stress are defined as an elevated susceptibility toward oxidative harm, after the consumption of a meal rich in lipids. It is well known that several compounds with notorious health effects could be produced during this oxidative degradation of food. Therefore, the prevention of lipid peroxidation in food has received increasing attention in the past decades.

Lipid peroxidation can cause quality deterioration in food products and meat. The peroxidation process starts immediately after slaughtering due to disruption of blood flow. Hence, in all the different stages of handling, food processing, and storing, a careful approach must be applied. Generally, all processing treatments disrupt membrane integrity and by doing so, increase exposure of the meat to pro-oxidant components such as oxygen and free iron. Processing factors such as prolonged cold storage and heat treatments have been shown to promote the oxidation of lipids. In addition, the lipid peroxidation process continues in the gastrointestinal tract after meat consumption following the absorption of advanced lipid peroxidation end products, such as reactive carbonyls.

A common practice in the meat industry involves inhibition of lipid peroxidation by the addition of antioxidants. But the meat industry is strongly restricted by the need to replace synthetic antioxidants with naturally-derived materials, leaving manufacturers with fewer possibilities. A review paper by Manesis et al. [Antioxidants (Basel), 2020 December; 9 (12), 1215] lists major classes of chemical antioxidants used by the meat industry: 1) phenol derivatives (butylated hydroxyanisole (BHA), butylated hydroxytoluene (BHT), tertiary butylhydroquinone (TBHQ), propyl gallate (PG) and synthetic tocopherol (vitamin E); 2) phosphates (e.g., tripolyphosphate, hexametaphosphate and pyrophosphate etc.); and 3) acids (organic, HCl). The aforementioned chemical antioxidants can be jointly used with chemical preservatives (e.g., nitrites, sulfites, benzoic acid and sorbic acid).

Recently, a crust from dry-aged beef was tested independently by two groups for its antioxidant activity and potential use as a food ingredient: Xue et al. [Meat Science 173 (2021) 108403] and Kimhackyoun and Park (a Korean patent application KR 10-2021-0063695, filed in the name of UNIV KONGJU NAT IND ACAD COOP GRO (UYKN-C). During dry-aging, as meat cuts are placed in a sanitized, refrigerated environment for several weeks or months, a dry protective layer—crust—is formed on the surface of the meat. The longer the duration of the dry-aging, the thicker the crust formed. The crust was separated from the meat, formed into a powder, and tested by the DPPH (2,2-diphenyl-1-picrylhydrazyl) assay.

The surface layer developed when meat is cooked over high heat, e.g., through heat-cooking methods such as grilling, roasting and pan-frying, is also named crust. The literature (see Portanguen et al., Food and Bioprocess Technology 7m 3308-3318 (2014)) has defined this type of crust as a dried evaporating area where the meat temperature is greater than the boiling water temperature, showing hardness and crustiness, with a distinct brown color that is visually distinguished from the gray-pink color characteristic of the layer just below the crust or of undercooked meat. With pan-frying, the temperature can rise up to 300° C. and it is considered to be a common domestic cooking process. During pan-frying, the external layer of the meat is in direct contact with the pan, and a crust is formed.

### The Invention

Experimental results reported below indicate that pan-fried meats show lower levels of lipid peroxidation as compared to microwave-cooked meats (lipid peroxidation levels were quantified by determination of malondialdehyde concentrations; malondialdehyde (MDA) is a major peroxidation product of polyunsaturated fatty acids and is often applied as peroxidation marker).

The crust formed over the pan-fried meats was isolated and tested by different assays to determine whether it has antioxidant properties, which may account for the reduced lipid peroxidation levels observed in pan-fried meats. Pan-fried crust was indeed found to possesses strong reduction action. For example, a crust generated over the surface of pan-fried beef patties was isolated and was shown to reduce ferric (Fe³⁺) to ferrous ions (Fe²⁺) much more effectively compared to meat of the middle of the patty. The pan-fried crust also demonstrated direct antioxidant activity: on addition of the isolated pan-fried crust to meat membrane, lipid peroxidation was significantly restrained (lipid peroxidation was induced by employing an acceptable prooxidant system consisting of ascorbic acid/Fe³⁺). The effect was shown to be dose dependent.

FIG. 1A is a scheme showing the main features of the invention, namely 1) pan-frying meat, 2) crust formation, and 3) the antioxidant effect achieved by addition of the pan-fried crust to foods, i.e., decreased lipid peroxidation with increasing amount of added crust. Preparation of meat crust with the desired properties is scalable, as frying appropriately flattened meat (e.g., a few mm thick patties) can convert almost the entire mass into a useful crust (~90-100% yield calculated on a dry basis). FIG. 1B shows, from left to right, an as-formed bulk crust, and its comminution into a powder useful as seminatural antioxidant ingredient, which may lead to extending shelf life with better nutritional properties of various food products.

Accordingly, one aspect of the invention is a process for preparing a meat-derived antioxidant, comprising cooking or heat drying meat by direct contact with a hot surface to form a crust and comminuting an isolated form of the crust, to obtain crust particles suitable for use as a food additive.

The meat from which the crust is produced may be obtained from livestock, namely, cattle (cows, calves), sheep, goats, pork (pigs), and horses and poultry (including chicken, turkey, ducks). Beef (including veal), chicken and turkey are the preferred types of meat for crust production.

Suitable cooking and drying methods involve heat transfer to the meat solely by thermal conduction, e.g., dry-frying the meat without added oil/fats/lubricants, on metallic surfaces made of cast iron, stainless and steel, anodized aluminum. Polytetrafluoroethylene (hereinafter PTFE or Teflon®) coated surfaces may also be used.

The cooking surface is preheated to a temperature of at least 70° C. and cooking is performed in the temperature range from 70 to 400° C., e.g., 100 to 400° C., preferably from 130 to 300° C., e.g., 180-300° C., e.g., 180-270° C., depending on the pan material, as shown below, with total cooking times varying from one minute to sixty minutes, e.g., from two to fifteen minutes, e.g., from four minutes to ten minutes (i.e., 2-5 minutes per side). The meat is placed in the cookware in a flattened form, e.g., ground beef is flattened to form patties, which are flipped (one or more times) such that each side is in direct contact with the hot surface for at least one minute, e.g., from two to five minutes (accumulating time).

Examples of cookware that can be used to create the crust include frying pans (the term is used herein interchangeably with skillets), without limitation, however, to a shallow, flat-bottomed design. Drying the meet over a large-sized flat cooking surface not encircled by vertical walls is perfectly fine, and also cooking/frying in pots.

Another approach to crust formation, well suited to industrial scale production, is by drum drying, i.e., with the aid of a drum dryer, constructed of cast iron or stainless steel, where heat transfer takes place to a material by conduction, as a thin layer of e.g., ground meat, is dried owing to contact with the outer surfaces of a pair of adjacent, internally heated, revolving drums, following which a dried film or a powder is collected.

Crust formation depends on various process variables, chiefly the type of meat, geometry of the flattened meat form, the cookware, cooking temperature and duration. Some preferred conditions leading to the formation of a crust exhibiting desired antioxidant activity are arranged in a tabular form below:

TABLE A

| | | Temperature | | Crust |
|---|---|---|---|---|
| Meat | Pan | T1-T2* | Time | thickness |
| Beef ground, | Cast-iron | 180-270 | a total up | <1.5 mm |
| flattened to ~2.5 mm | Stainless | 70-180 | to five | |
| thick patties | steel | | minutes, | |
| | Teflon ® | 180-220 | flipping | |
| Turkey ground, | Cast-iron | 180-270 | sides | |
| flattened to ~2.5 mm | Stainless | 70-180 | every 1-2 | |
| thick patties | steel | | minutes | |
| | Teflon ® | 180-220 | | |
| Chicken ground, | Cast-iron | 180-270 | | |
| flattened to ~2.5 mm | Stainless | 70-180 | | |
| thick patties | steel | | | |
| | Teflon ® | 180-220 | | |

*Pan is preheated to T1 and higher, and cooking is between T1 and T2.

The process variables may be adjusted by simple trial and error experiments as the crust formed can be straightforwardly tested for its reductive character by a colorimetric assay using the Fe³⁺/ferene system (Fe²⁺ formed by the reduction of Fe³⁺ by the crust, reacts with ferene to form a stable, water-soluble, deep blue, colorimetrically measurable complex, as previously described (Abbasi, U. et al. 2021, A facile colorimetric method for the quantification of labile iron pool and total iron in cells and tissue specimens. Sci. Rep. 11 (1), 6008). The result is expressed as Fe²⁺ concentration in solution, and a crust is considered acceptable when 100 mg crust reduce at least 10 micromolar of Fe³⁺. Another assessment is by a comparison of the Fe²⁺ concentration in solution produced by the action of the crust, either with Fe²⁺ concentration measured when a reference reductant such as ascorbic acid is used in excess, or with Fe²⁺ concentration measured when the bulk meat, on which the crust was formed, and from which it was isolated, is applied in equimolar amount to reduce Fe³⁺.

It should be noted that the crust (namely, the dark, brown hard external layer of a meat produced when the meat comes into direct contact with a heated surface) is used in an isolated form, i.e., substantially free from inner, softer, and lighter in color meat layers that were not in direct contact with the heated surface (e.g., not more than 20% of the total weight of the crust is made of bulk meat, i.e., <10 wt. %, <1 wt. %, e.g., from 0 to 0.1 wt.). Sometimes, the crust would have to be separated mechanically (e.g., manually or with appropriate tools) from the “non-crust” meat layers (the inner layers not in contact with the heated surface), and crushed to produce grains, crumbs, or powder, by any manner known in the art, so it can be spread evenly in the final food product to which it is added. Typically, the size of the crumbs/grains is between several millimeters and half a centimeter in length.

Thus, the invention specifically provides a process which comprises placing meat on a heated iron surface for a short duration of time, sufficient to produce crust, isolating the formed crust and crushing it. However, as shown in the experimental section below, appropriately flattened ground/sliced meat, e.g., fairly thin beef patties, (<5 mm thick, e.g., ≤3 mm, formed with the aid of an adjustable rolling pin equipped with silicon rings to determine the thickness required) could be turned into a crust mass in their entirety such that crust separation from the bulk meat may not take place. Accordingly, the invention provides a process comprising cooking/heat drying ground or sliced meat in a flattened form at thickness lower than 5 mm (e.g., ≤3 mm) to convert the entire mass into crust and comminuting the crust, e.g., to form a powder.

Furthermore, it should be noted that meat drying by direct contact with a hot surface to form crust, and crust processing by particle size reduction, are not necessarily performed in a successive manner as certain types of equipment, e.g., drum driers, may perform the two actions practically simultaneously.

The invention further contemplates the cooking and heat drying of a marinated meat, that is, after the meat has been immersed in, and soaked with, a marinade (i.e., a plant-based liquid) comprising fruits and vegetables that are high in antioxidants in their own right, e.g., a pomegranate-based marinade and a beetroot-based marinade, to name a few examples. “Marinated” meat crust powder prepared through thermal conduction by direct contact with a hot surface has shown strong antioxidant activity when incorporated in, e.g., turkey meat.

Another aspect of the invention is a food additive for restraining oxidation of food products, comprising meat crust in a comminuted form, e.g., beef, chicken, or turkey crust, especially in a powder form (e.g., particle diameter from 0.1 to 4 mm, 0.1 to 2.0 mm, 0.1 to 1 mm), with typical brown or dark brown color, showing at least one of the following characteristics:
A) water content of less than 10.0 wt. %, e.g., less than 7.0 wt. %, e.g., from 0.0 to 3.0 wt. %;
B) Maillard reaction products indicated by
   B1) protein carbonylation, e.g., not less than 40 nmol of protein carbonyls (PCO; ketone/aldehyde derivatives) per 1 mg protein, e.g., >50 nmol, for example, from 40 nmol to 70 nmol, as measured by reacting the crust with 2,4-dinitrophenylhydrazine (DNPH) to form hydrazone; and/or
   B2) advanced glycation end products (AGE), e.g., not less than 20 ng per 1 μg protein, e.g., from 20 to 30 ng per 1 μg protein, measured, for example, by commercial assay kits;
C) 100 mg of crust reduces at least 10 micromolar of Fe³⁺, as measured by the Ferene colorimetric assay; and
D) elemental analysis (C, N, H, O, S) is essentially comparable (+10%) to elemental analysis of the corresponding raw meat (for example, for entrecote meat, the following ranges are representative):

| | C (%) | N (%) | H (%) | O (%) | S (mg/kg) |
|---|---|---|---|---|---|
| Crust | 53.0-55.0 | 13.0-15.0 | 9.0-10.0 | 22.0-24.0 | 7300-7600 |
| composition | | | | | |

The food additive provided by the invention is a meat crust obtainable or obtained by thermal conduction, for example, a pan-fried meat crust or drum-dried meat crust. The term “food additive” refers to a composition that is GRAS approved (generally recognized as safe), sold as a product (article of manufacture) to be added to various food products for the purpose of improving flavor, texture, and preservative qualities.

The food product to which the additive of the invention is added may be: unprocessed meat products, ground meat products, cured meat, processed meat products and alternative meat products, frozen meat, emulsions and sauces, and also cultured meat products.

The additive of the invention acts as an antioxidant, to lower peroxidation levels of lipids in the food product and peroxidation of vitamins, proteins, and other nutrients in the food product. Thus, additional aspects of the invention include a food product comprising the meat crust antioxidant; a method for lowering peroxidation of a food product by addition of the meat crust antioxidant to the food product; and a use of a comminuted form of a meat crust generated by thermal conduction as a food antioxidant.

The meat crust antioxidant is added in a concentration ranging from 0.1 to 2.5 wt. %, e.g., from 0.5 to 2.0 wt. %, based on the total weight of the food product. Greater amounts are possible, provided that the taste and flavor of the food product are not impaired. In a preliminary organoleptic test, two judges tasted grilled burgers, with 2 wt. % crust or additive free. The judges were asked to scale the taste separately on a 1-10 hedonic scale labeled 1 “disliked most” and 10 “liked most”. The crust-containing products scored better than the crust-free burgers (two points higher than the crust-free).

The addition of the meat crust antioxidant to the food product is performed by customary techniques, bearing in mind that the additive is slightly soluble or water-insoluble. The addition may be done by mixing the food additive with the food product, coating the food product with the food additive (by dipping, spraying, rubbing, etc.).

For example, in the meat processing industry, in the production of uncooked frozen beef meat patties for home cooking, after the initial grinding of the raw meat, the coarsely ground meat is introduced into a meat blender where it is thoroughly mixed with customary additives (e.g., seasonings, etc.), and the meat crust antioxidant of the invention, to evenly distribute all ingredients and form a uniform mixture. The meat crust antioxidant is added to the meat blender in a powder form or suspended in water. After final grinding, the meat is shaped into patties using suitable forming machines and then the patties enter a freezing system (e.g., a blast freezing system, a mechanical freezing system or cryogenic freezing system), packed (e.g., vacuum packed) and stored until cooking. In the production of frozen cooked (e.g., beef) patties, the meat crust antioxidant of the invention can be added just prior to cooking, before freezing.

Experimental results reported below show the potent antioxidant activity of the meat crust of the invention in frozen hamburgers. On addition of, e.g., 2 wt. % (cast-iron) pan-fried crust to entrecote ground beef, patties were formed, which were kept frozen in vacuum begs at 7 millibars at −20° C. for three- or seven-days storage period (the control group consisted of crust-free hamburgers). Then hamburgers were cooked in a Ninja grill, and MDA levels measured in crust-added patties 60 minutes after preparation were lower compared to crust-free patties (the 60 minutes time interval matches GI digestion).

Thus, frozen beef meat patty, to which was added the meat crust antioxidant described above (e.g., 0.5 to 2.5 wt. % relative to the total weight of the patty), forms specific aspect of the invention.

The meat crust antioxidant can be incorporated into other forms of meat. That is, meat tumblers can be used by the industry to add the meat crust antioxidant into meat/chicken slices. Domestic cooking and restaurant kitchen can also benefit from the use of the meat crust antioxidant food additive of the invention, to be added to meat before cooking, by blending, rubbing, etc.

Addition of the meat crust antioxidant to a food emulsion (oil-in-water) has led to increased stability of the emulsion against peroxidation. Lipid oxidation in the emulsion was induced by a conventional oxidation system (consisting of ferric chloride and ascorbic acid at 37° C. at different times of incubation). The added crust showed strong antioxidant action, with pan-fried crust formed on cast iron, stainless steel and Teflon made-surfaces all effectively protecting the oil from peroxidation by the AA/iron pair redox system. Food emulsions and sauces can therefore greatly benefit from the addition of the antioxidant of the invention. For example, sauce manufactures can employ equipment designed for sauce production where loading of solid ingredients is needed, to enable the dosing of the meat crust powder of the invention, to become uniformly and stably suspended in the sauce. For example, using production units available from Inoxpa® for sauce manufacture.

Thus, food emulsions (e.g., emulsion sauces) and sauces in general, such as steak sauce, teriyaki sauce, soy sauce, and other liquid seasonings, to which was added the meat crust antioxidant described above (e.g., 0.5 to 2.5 wt. % relative to the total weight of the product), form specific aspect of the invention.

In the experimental work reported below, beef patties and chicken chops were fried/dried by heat conduction owing to direct contact between the meat and a variety of pans and the meat surface developed brown crust involving the Maillard reaction. Specifically, the effect of two heat treatments (pan frying (PF) and microwave (MW)) on the lipid peroxidation process in turkey and beef rib eye steak (Entrecote) was studied. In addition, the effect of the pH following incubation at 37° C., in intestinal and gastric pH, on lipid peroxidation in the cooked meat, was tested. An increased oxidizability of meat at intestinal pH 6 versus gastric pH 3 was found. Moreover, PF-treated meat was found to be significantly less susceptible to the accumulation of lipid peroxidation products compared to MW-treated meat due to the crust layer and its antioxidant abilities.

The differences in lipid peroxidation between the different pHs could be explained by myoglobin activity as peroxidase in various pHs. The myoglobin acts as a catalyzer in the breakdown of lipid hydroperoxides and was found to be highly effective at lower pHs, like in the gastric, compared to higher pH levels, such as found in the intestine. Therefore, fresh and minimally oxidized meat under the stomach conditions could promote the activation of myoglobin antioxidant effect and even prevent downstream oxidation in the low-oxygen environment of the intestine. However, under conditions of regular processing and high levels of hydroperoxides in the meat, the stomach pH can potentiate more oxidation.

An entrecote-derived crust has been shown to possess antioxidant activity due to its ability to act as a reducing agent as was demonstrated by the efficient reduction of ferric ions to ferrous (Fe⁺²). A possible mechanism for the crust-reducing ability is through the Maillard reaction products (MRPs). The initiation of the Maillard reaction; a chemical and non-enzymatic browning reaction, is through the storage of foods and thermal processing and involves free amino and carbonyl groups. Various compounds of MRPs such as Amadori rearrangement products and melanoidins have been reported for their antioxidative ability due to various mechanisms such as scavenging of reactive oxygen species (ROS) and chelation of metal ions.

Another useful assay to determine reduction capacity of the crust is based on the tri-iodide-starch test. The amount of solution needed to be tittered in the KI₃ titration was more than double for the crust compared to AA. Although AA is a powerful reducing agent, the crust has a substantially higher iodine removal capacity. A possible explanation is that the crust acts as a scavenger for iodine due to the formation of molecules with double bonds. The crust displays a significant antioxidant capacity probably due to scavenging the iodine radicals, resulting in an extensively higher amount of KI₃ solution needed to react with the starch indicator.

To evaluate the isolated crust antioxidant potential, meat membrane (washed meat) was used to study the crust's capacity to prevent lipid peroxidation. A substantial decrease in lipid peroxidation levels in the presence of the crust was observed. Although the crust did display chelation capacity, it was not found to be an efficient chelator for ferrous. This means that there is a direct antioxidant effect on the lipid membrane as propagation suppressor of lipid peroxidation in the meat regardless of the inhibition of initiation by chelation through ingredients or components that are part of the heated meat tissue.

MW heating was shown to cause more structural damage in various types of meat. The SEM images in this study show extensive damage after MW heating, compared to PF in turkey meat, but not in entrecote meat. A visible correlation can be distinguished between the physical damage and membrane disruption made and the amount of MDA accumulation post treatments within the meats.

No statistical difference in fatty acid distribution post-heat treatments compared to raw meat was found. The increase in lipid peroxidation products can be attributed to the physical damage to the meat following incubation. From a culinary point of view, the “sealing” of the meat from all sides by PF could be a good method to decrease lipid peroxidation during cooking and digestion.

The physical sealing of the meat by PF treatment and the fact that no significant change was observed after heating in the fatty acid profile, is an indication that PF treatment is less deleterious before consumption in terms of lipid peroxidation levels, while the chemical properties of the crust are protective in the simulation of postprandial incubation at different pHs.

### BRIEF DESCRIPTION OF THE DRAWINGS

FIG. 1A (i-iii) is an artistic scheme showing the main features of the invention and FIG. 1B (i-iii) shows from left to right, an as-formed bulk crust, and its comminution into a powder.

FIGS. 2A and 2B are MDA levels versus time plots showing accumulation of MDA in turkey (2A) and entrecote (2B) after PF and MW followed by exposure to pH 6 (intestine) and pH 3 (gastric).

FIGS. 3A-3D are surface images of turkey meat after MW (A, B) and after PF (C, D). FIGS. 3E-3H are surface images of entrecote meat after MW (E, F) and after PF (G, H).

FIG. 4A shows protein carbonyls (PCO) content in the crust and MB presented as nmol per mg of protein. FIG. 4B shows the AGEs quantity in the crust layer versus the MB as ng per μg of protein.

FIGS. 5A-5C shows the redox properties of an entrecote crust as evaluated by different assays described in Example 4. The statistical tests were made on the results using Dunnett's methods test. Differences were considered significant at p≤0.05 and indicated by different letters (n=2).

FIGS. 6A-6B show evaluation of antioxidant properties and a dose-dependent effect of the crust. MDA accumulation within 60 minutes in entrecote MP with catechin (400 μM), crust, and middle of the beef Pattie (MB) (both 100 mg) (A). Dose dependent antioxidant effect of crust: MDA accumulation within 60 minutes in turkey MP with various amounts of crust (B). The statistical tests in graph A were made on the difference in MDA after being given within 60 minutes using Student's t-test. In graph B The statistical tests were made using Dunnett's methods test on the difference in MDA after being given within 60 minutes. Differences were considered significant at p≤0.05 and indicated by different letters (n=4).

FIG. 7 shows MDA concentrations measured at different times expressed as nmol/ml emulsion, for the experiments of Example 8, achieved by crusts produced on different pans.

FIG. 8 shows MDA concentrations measured at different times expressed as nmol/ml emulsion, for the experiments of Example 9, achieved by crusts derived from different types of meats.

FIGS. 9A-9B are bar diagrams showing that crust powders produced from a variety of meats on different surfaces (cast iron, Teflon®) all provided good protection against peroxidation in a tested emulsion system.

FIG. 10 shows antioxidant activity of meat crust in frozen hamburgers (MDA levels).

FIG. 11 shows suppression of peroxidation in turkey membrane phase by addition of a marinated pan-fried generated entrecote crust.

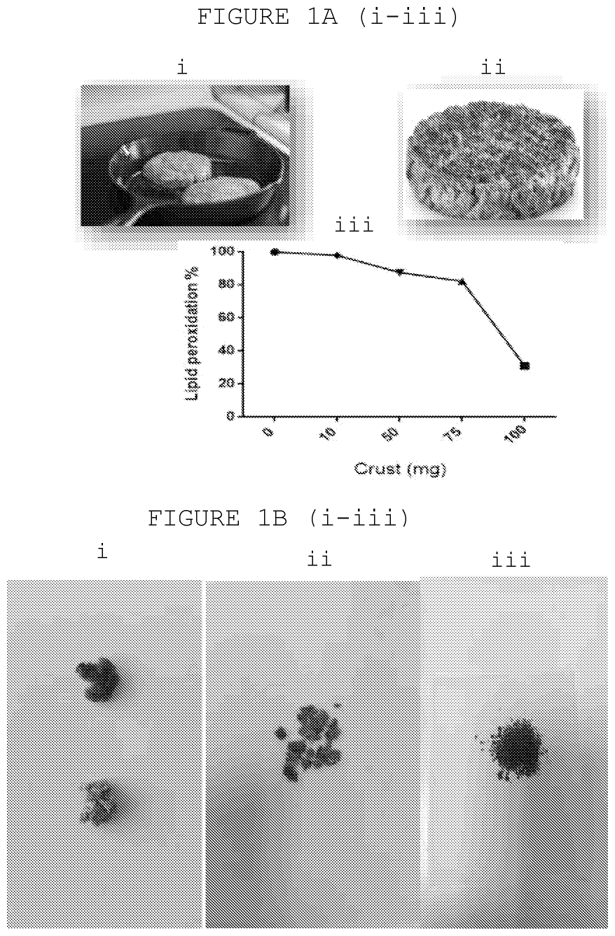

The results shown in the appended graphs and reported below are expressed as mean±standard deviation (SD). The data were analyzed by analysis of variance with one-way analysis of variance post hoc Tukey-Kramer HSD test, Student's t-test, and Dunnett's methods test using JMP Pro 16.0.0 (SAS Institute, Inc.) software. The statistical tests were performed on the results obtained either: immediately, after 60 minutes, or on the differences (DeltaA), between the baseline and after 120 minutes. Differences were considered significant at p≤0.05 and were indicated by different letters.

### EXAMPLES

### Materials

Turkey & entrecote were bought at two different commercial stores in Israel, on separate occasions. Hydrochloric acid (HCL) 37%, sodium chloride, and chloroform were purchased from Bio-Lab Ltd. (Jerusalem, Israel). Sodium hydroxide and toluene were purchased from Frutarom (Haifa, Israel). 2-thiobarbituric acid (TBA), methanol, ascorbic acid (AA), ferene, iron (III) chloride anhydrous, and catechin were purchased from Sigma-Aldrich (St. Louis, MO) and Trichloroacetic acid (TCA) was bought from Merck (Darmstadt, Germany). Potato starch was bought from BDH (BDH limited Poole, England) and Meth-Perp 2 from Alltech (Alltech Associates Inc.) Potassium iodide was purchased from J.T. Baker (J.T. Baker, USA). To simulate the gastric pH, simulated gastric fluid (SGF) was used. The fluid was freshly prepared according to the United States Pharmacopeia (Rockville, MD; 2000) without pepsin. The SGF contained NaCl (200 mg), and HCl (700 μL of 37%) that were added to Double-distilled water (DDW, 100 mL). The intestine relevant-pH fluid (IRF) contained 100 mL of DDW and NaCl (200 mg) and this fluid was adjusted to pH 6 with 1 M HCl.

### Example 1

### Characterization of Raw Turkey and Entrecote Before Cooking

Fat percentage was determined by the Folch method (Sündermann et al. 2016. Liquid extraction: bligh and dyer. Encyclopedia of lipidomics. In: Wenk M R. Springer Netherlands, pp. 1-4). 5 g of ground turkey or entrecote were homogenized at a 1:3 ratio with DDW (w/v). 1 ml of the homogenate was diluted 1:5 with chloroform-methanol (2:1) along with 1 ml of water. The lower organic phase was collected in pre-weighed test tubes, left to dry completely, followed by weighing the tubes to estimate the mass of extracted fat. The results were presented as percentage (%) of the fat content.

Moisture percentage was determined by placing ground turkey or entrecote at quantity of 5 g in an oven for 18 h at 105° C. The dried meats were weighed after 18 h, and the resulting weight differences were presented as moisture (water content) (%).

Initial levels of lipid peroxidation were determined by homogenizing the grounded meats (Polytron PT 3000) with three portions of DDW. The homogenate was mixed immediately with 12% TCA at a 1:1 ratio and centrifuged (Thermo Fisher, Heraeus Megafuge 16 R) for 10 min at 10,000 RPM at 4° C. Lipid peroxidation was determined by measuring TBA reactive substances (TBARS) which were expressed and calculated as malondialdehyde (MDA) levels. The supernatant after the centrifuge was mixed with TBA (10 mM) at a 1:1 ratio, and the samples were heated in a boiling water bath for 15 min. Then, the absorbance of the samples was measured at 532 nm (Shimadzu UV-1700, PharmaSpec), and the MDA was calculated according to 1 μmol/L=0.156 absorbance and expressed as nmol/g meat.

The results (fat %, moisture % and lipid peroxidation as MDA levels) are tabulated in Table 1, as mean±SD of triplicates.

TABLE 1

| | | | Level of lipid |
|---|---|---|---|
| | | | peroxidation as |
| | Fat (%) | Moisture (%) | MDA (nmol/g meat) |
| Entrecote | 24* | 72.3 ± 0.54 | 4.68 ± 0.17 |
| Turkey | 17.3 ± 1.88 | 76.6 ± 0.24 | 7.69 ± 0.08 |

*mean of duplicate.

### Example 2

### Effect of Pan-Frying Versus Microwave Cooking on Lipid Oxidation in Turkey and Entrecote and Characterization of Meat Surface

After purchase, the ground turkey or entrecote were weighed to 5±0.05 grams and kept at −80° C. until use. The patties were shaped at the same thickness (10 mm).

For the microwave cooking (Dow, South Korea, at 800 W), the meat patties were heated for 1 minute precisely, developing a light brown color.

For the pan-frying cooking, cast-iron pans were used. The patties were placed for 3 minutes exactly per side on a hot pan without oil. A cast-iron pan (3 mm thickness) was warmed on an electric stove (Rotel AG, Switzerland) to 180° C. The internal temperature of the patties after heating achieved 70° C. and the patties' middle color changed to a mild brown.

After the preparation, the meat patties were homogenized (Polytron PT 3000) with three portions of SGF/IRF. Later on, the homogenate was adjusted either to pH 3.0 or pH 6.0 and was incubated in a shaking bath at 37° C. for 120 min. During the incubation, homogenates were sampled at 4-time points (0, 30, 60, and 120 min) followed by estimation of the lipid peroxidation level by measuring TBARS as described in Example 1, and the results were expressed as MDA (nmol/g meat).

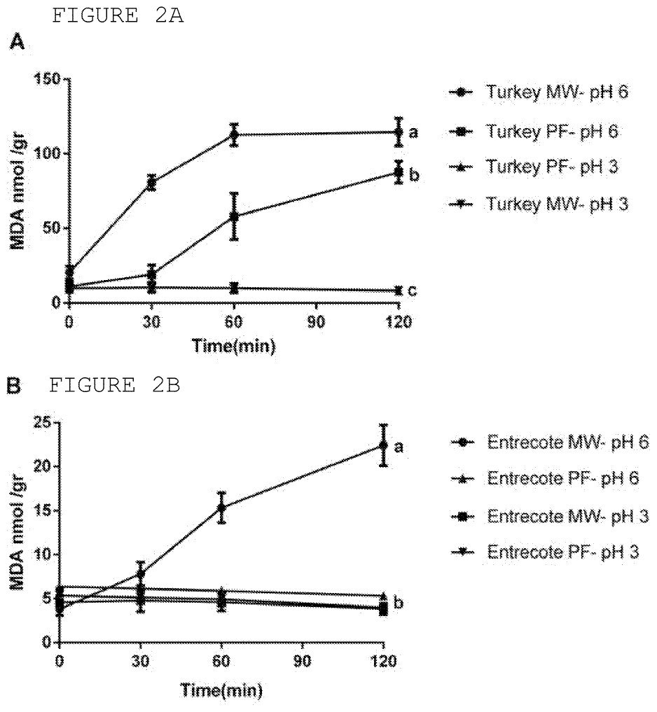

The results are shown in FIGS. 2A (turkey samples) and 2B (entrecote samples) as MDA levels versus time plots. Differences were considered significant at p≤0.05.

FIG. 2A shows that MDA accumulation in MW-cooked turkey incubated at intestinal pH 6 (curve a, marked by circles) was significantly higher compared to MW-cooked turkey and PF-cooked turkey in gastric pH 3 (p<0.0001). The MDA levels in PF-cooked turkey after incubation at pH 6 (curve b, marked by squares) were significantly lower than the levels found in the MW-cooked turkey at pH 6 (p=0.01). Each experiment was repeated four times with triplicates (n=12). The statistical test was made using the delta change between 0 time and 120 min within each sample and a comparison of mean values of the change between treatments was done using Student's t-test.

FIG. 2B shows that MDA levels in MW-cooked entrecote exposed to pH 6 (curve a, marked by circles) were much higher compared to all other entrecote treatments (p<0.0001). Similarly to turkey, a mild decrease with time was observed in entrecote meats placed in gastric pH 3 after both MW and PF cooking. Each experiment was repeated four times with triplicates (n=12). The statistical test was made using the delta change between 0 time and 120 min within each sample and a comparison of mean values of the change between treatments was done using Student's t-test.

To assess the impact of the different heating methods on the meat surface (MW and PF), an analysis was performed via an electronic microscope (SEM Jeol IT 100, working conditions: 20 kv WD10 mm). The samples were prepared as previously described [Fischer et al. (2012). Unit 2B2. Scanning Electron Microscopy. Curr Protoc Microbiol, 25, 2B.], with some modifications. Briefly, post fixation with glutaraldehyde 4% in phosphate buffer, the samples were rinsed in the same phosphate buffer 5 times every 10 min and left at 4° C. overnight. After that, the samples were dehydrated in a series of solutions with increasing ethanol concentration as follows: 25%, 50%, 75%, and 95% of ethanol for 20 minutes for each concentration. Lastly, samples were added to 100% ethanol, four times for 30 min each, dried in a Critical Point Dryer (K850 Quorum). The rest of the protocol was conducted as described by Fischer et al (supra), with the samples being mounted on metal stubs and coated with gold (Q150T ES Quorum).

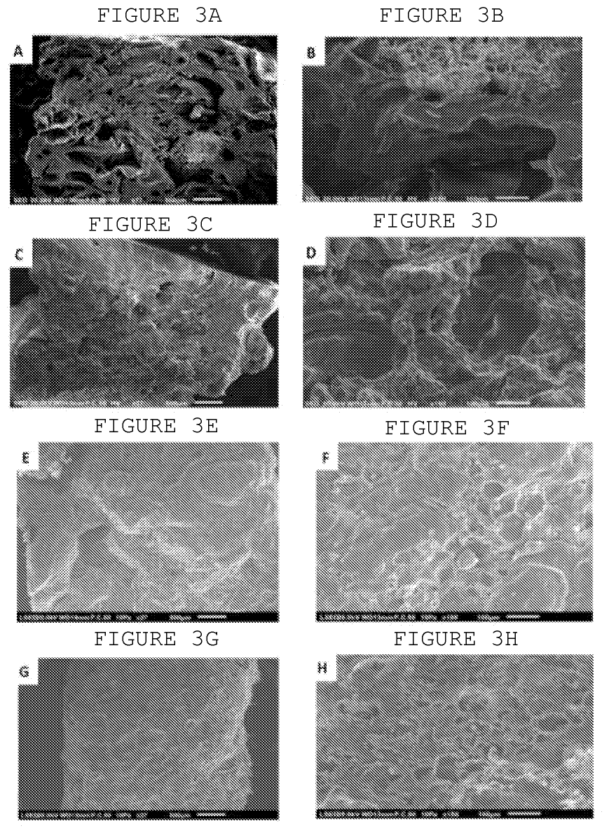

The images are appended in FIGS. 3A-3D (turkey; after MW (A, B) and after PF (C, D)) and in FIGS. 3E-3H (entrecote, after MW (E, F) and after PF (G, H)). Turkey after MW showed a meat surface with meaningful damage and an extensive number of pores compared to turkey after PF which possesses a typical solid crust (FIGS. 3A and 3B, respectively). Post-enlargement of the images shows the depth and shape of the pores, and the effects MW heat has compared to PF heat (FIGS. 3B and 3D, respectively). Entrecote meat after MW did not show extensive damage as seen in turkey after MW (FIGS. 3E and 3F). Like turkey meat, entrecote post-PF had a common crust produced during cooking, showing solid homogenous surface (FIGS. 3G and 3H).

### Example 3

### Assaying Maillard Reaction Products in a Pan-Fried Crust Formed Over a Meat Patty in Comparison to the Interior of the Patty

After frying beef patties on a cast iron pan as described above, the patties were divided into the crust layer (that was chopped into small pieces), and the middle of the beef patty (MB). The MB was used as comparison factor to the entrecote crust.

The Maillard Reaction products were quantified by two assays. The first assay estimated the protein carbonylation (PCO), and was performed as previously described (Colombo, G. et. al, 2016. A step-by-step protocol for assaying protein carbonylation in biological samples. J. Chromatogr. B 1019, 178-190). The second assay was a quantification of the advanced glycation end products (AGEs) using a commercial competitive ELISA kit (OxiSelect™ STA-817, Cell Biolabs, Inc. San Diego, CA, USA) according to manufacturer instructions.

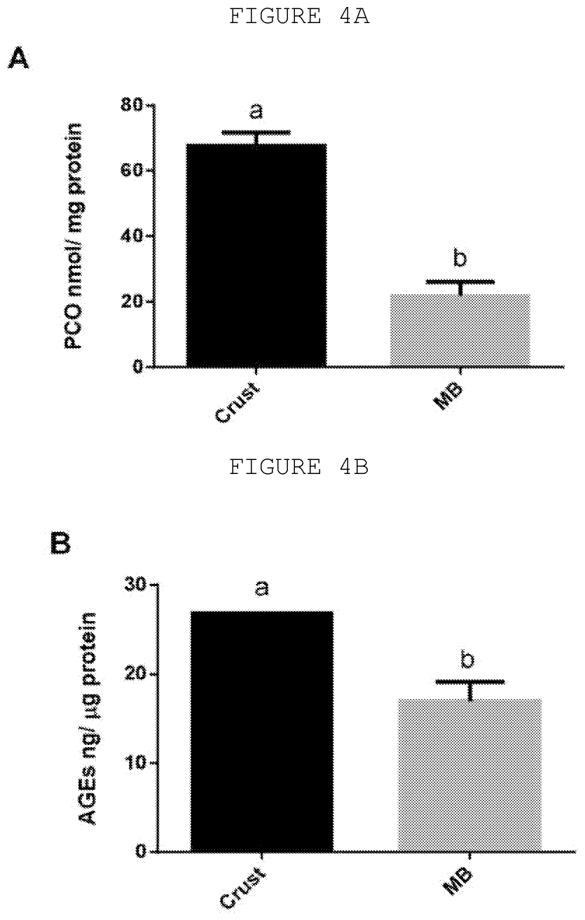

The results are shown in FIGS. 4A and 4B. The bar diagram in FIG. 4A indicates that the levels of PCO in the crust were noticeably higher compared to the quantity found in the middle of the beef patty per mg of total protein (p<0.05). The bar diagram in FIG. 4B shows that the crust had significantly higher AGEs levels versus the MB (p≤0.05).

### Example 4

### Evaluating Pan-Fried Generated Meat Crust with Antioxidant Capacity Assays

After frying beef patties on a cast-iron pan as described above, the crust was isolated from the meat for evaluation of its action as an antioxidant by different assays. The middle of the beef patty (MB) was again used for the purpose of comparison.

### Crust Reducing Quantification Assays

The first assay to test the reducing capacity of the crust involves ferric (Fe³⁺) reduction to ferrous (Fe²⁺) using the ferene-based iron assay. Ferene reacts with Fe²⁺ to form a stable, water-soluble deep blue complex, enabling colorimetric quantification of Fe²⁺ formed by the reduction of Fe³⁺, as previously described (Abbasi, U. et al. 2021, A facile colorimetric method for the quantification of labile iron pool and total iron in cells and tissue specimens. Sci. Rep. 11 (1), 6008). Four treatments 4A-4D were performed. In all cases, 5 mM of ferene was added to a tube charged with Fe³⁺ salt, either alone (4A), or in combination with the crust (4B), a conventional reductant (ascorbic acid, 4C) and the MB (4D), as tabulated below.

TABLE 2

| | |
|---|---|
| 4A | FeCl₃ 20 μM |
| 4B | FeCl₃ 20 μM + 100 mg crust |
| 4C | FeCl₃ 20 μM + 100 μM ascorbic acid |
| 4D | FeCl₃ 20 μM + 100 mg MB |

The tubes were centrifuged at 5000 RPM for 5 minutes. The supernatants were filtered by using a PVDF 0.22 UM filter and the samples were measured at 595 nm. Using a calibration curve, the results were expressed as μM of ferrous Fe²⁺.

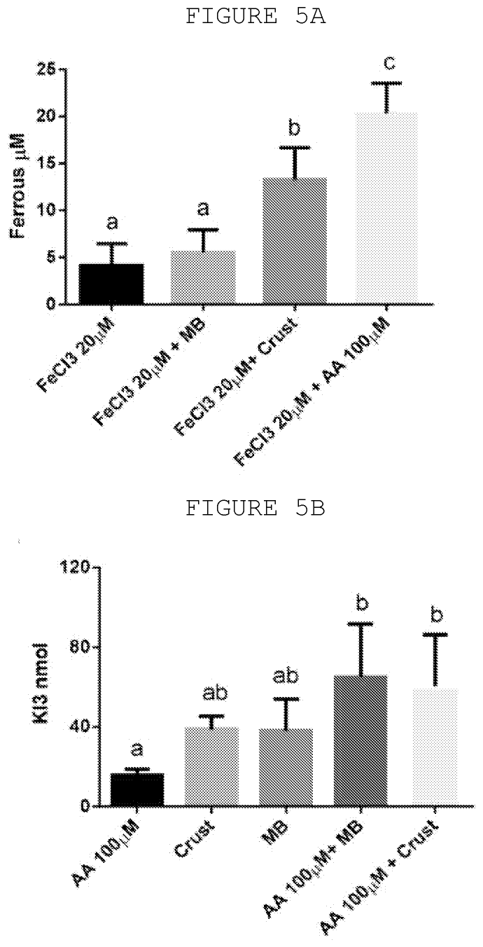

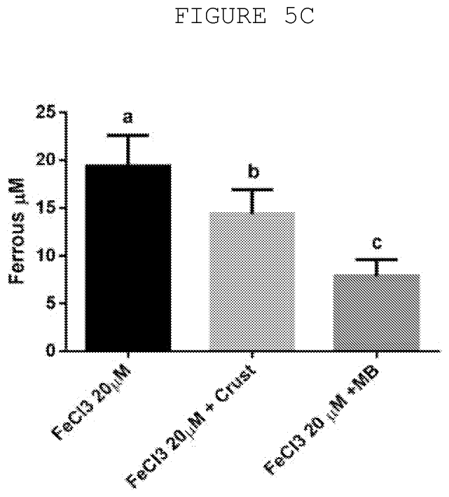

The results are shown in the form of a bar diagram in FIG. 5A, with the concentration of the reduction reaction—ferrous (Fe²⁺)—as the ordinate. Ascorbic acid (AA) was used as a reference: the sample containing iron with an excess of AA, produces the highest concentration ferene-ferrous complex among all of the treatments. The results attest to the potent reducing action of the crust: addition of 100 mg of entrecote crust to Fe³⁺ solution resulted in reduction of the ferric ion to ferrous at significantly higher level compared to the effect achieved with 100 mg of the middle of the beef Pattie (MB) and iron (Fe⁺³) alone (p≤0.05).

The second assay to evaluate the reducing ability of the crust involves reduction of elemental iodine to iodide, using the tri-iodide-starch test with a redox titration performed as follows. Five different treatments 4E-4I were tested. Tubes were charged with a conventional reductant (ascorbic acid, 4E), the crust (4F), the MB (4G), a combination of the crust and ascorbic acid (4H) and a combination of the MB and ascorbic acid, tabulated below.

TABLE 3

| | |
|---|---|
| 4E | 100 μM ascorbic acid |
| 4F | 100 mg crust |
| 4G | 100 mg MB |
| 4H | 100 mg crust + 100 μM ascorbic acid |
| 4I | 100 mg MB + 100 μM ascorbic acid |

The tubes were centrifuged at 10,000 RPM for 5 minutes. The supernatants were filtered and transferred to a tube containing 0.5% potato starch and water (creating a ratio of 1:6:40 between the starch, sample, and water, respectively). A tri-iodide solution (0.5 mM) was used for titration the samples and the final titration point was appointed as soon as the blue color of the starch-iodine complex appeared. The results were expressed as nmol of KI₃ needed for titration.

The results are shown in the form of a bar diagram in FIG. 5B. Between the samples containing crust/MB with AA versus AA alone, there was a statistically significant elevation in the amount of KI₃ solution needed for the titration (p=0.01, p=0.02, respectively).

### Crust Chelation Quantification Assays

Three treatments were studied, as tabulated in Table 4 below. Tubes were centrifuged at 5000 RPM for 5 minutes. The supernatant was filtered, and 100 μM of ascorbic acid (AA) was added, then the samples were vortexed vigorously, and 5 mM of ferene was added. The tubes were read at 595 nm and the results were expressed as μM of ferrous using a specific calibration curve.

TABLE 4

| | |
|---|---|
| 4J | FeCl₃ 20 μM |
| 4K | FeCl₃ 20 μM + 100 mg crust |
| 4L | FeCl₃ 20 μM + 100 μM MB |

The results are shown in the form of a bar diagram in FIG. 5C. The samples containing 100 mg of MB with iron have shown the highest chelation capacity compared to all other treatments. The addition of the crust produced a significantly lower ferene-ferrous complex formed versus iron (ferric ions) alone (p≤0.05).

### Example 5

### Evaluating the Antioxidant Effect of a Pan-Fried Entrecote Crust Added to Meat Membrane

The washed meat residue system was performed as follows: fresh entrecote meat was homogenized with four portions of pH 6.5 acetate buffer 0.05 M. The liquid was centrifuged at 14,000 RPM at 4° C. for 30 minutes. Then, the supernatant was discarded, while the residue was weighed and supplemented with the acetate buffer (four times the residue weight). After 30 minutes this process was repeated and, overall, was conducted three times to produce the membrane phase (MP). The same process was performed for turkey meat. The entrecote MP (0.5 g) was homogenized with IRF, and the crust (100 mg) and MB (100 mg) produced from entrecote after PF were added to tubes separately. Catechin (400 UM) was added as a positive control. Next, 10 μM of FeCl₃ and 100 μM of AA were added, each tube had a final volume of 5 ml, and the MDA levels were quantified via TBARS within 60 minutes.

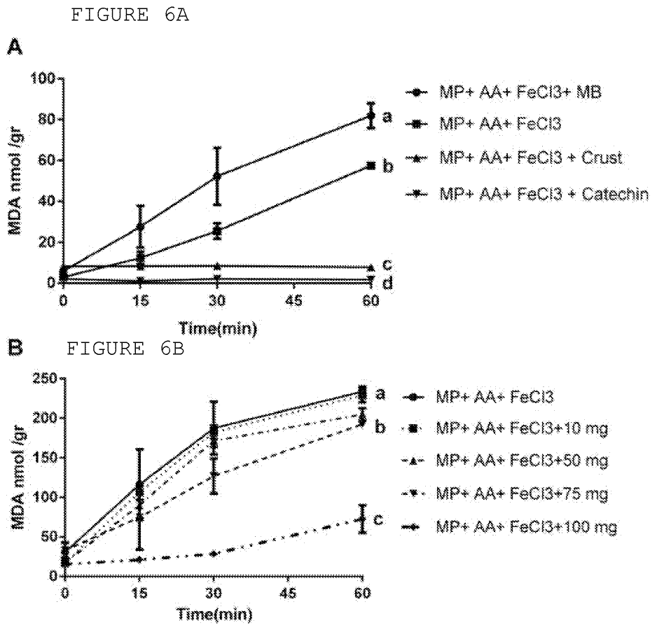

The results are shown in FIG. 6A as MDA levels versus time curves. It is seen that addition of crust to the isolated meat membrane inhibited the pro-oxidant effect of AA/iron and has led to significantly lower lipid peroxidation levels compared to only iron and AA (p<0.0001). The addition of the MB has led to the highest MDA accumulation after 60 minutes. The crust and catechin produced the lowest MDA levels and there was no statistical difference between the two.

The dose-dependent effect of the crust on lipid peroxidation was determined using the following crust quantities: 10, 50, 75 and 100 mg. Turkey MP samples were employed in this assay, due to the fatty acid composition of turkey, and the same protocol as was previously described was conducted. The turkey MP (0.5 g) was homogenized with the IRF, and the crust in various amounts was added. After addition of 10 μM of FeCl₃ and 100 μM of AA followed by adjustment to a final volume of 5 ml, the MDA levels were quantified within 60 minutes.

FIG. 6B shows the dose-dependent effect of the crust on turkey MP. The highest MDA levels were observed in the control samples (MP with iron and AA) and in the samples containing 10 mg of crust. There was a significant difference between the last two and the samples treated with 75 and 50 mg of crust (p<0.03). The addition of 100 mg has led to the lowest MDA accumulation and was significant versus all treatments (p<0.0001).

### Example 6

### Fatty Acid Composition Analysis

The total lipids were extracted from the meats after heating by the Folch method as described by Sündermann et al. supra, with several modifications. 3 ml of DDW was added to 1 g of meat. After grounding, the samples were diluted to a 1:10 ratio with DDW. 1 ml of the homogenate was taken and diluted with four volumes of chloroform-methanol 2:1 mixture. The lower layer was collected after centrifuge for 10 minutes at 800 RPM. The samples were evaporated with nitrogen, and for further drying, 200 μl of tert butyl was added to each sample. Samples were put in a freezer for approximately 4 hours and lyophilization.

After Lyophilization, 100 μl of toluene, 20 μl of methanol, and 40 μl of Meth-Prep II (sodium methoxide) were added and samples were subjected the Gas Chromatography (GC). Chromatographic analysis was performed with a GC apparatus (Agilent Technologies, Santa Clara, CA, USA) equipped with a fused-silica capillary column (60 m×0.25 mm ID, DB-23, Agilent Technologies) under the following conditions: the oven temperature was programmed from 130° C. to 170° C. at a rate of 27° C./min, from 170° C. to 215° C. at a rate of 2° C./min, held at 215° C. for 8 min, from 215° C. to 250° C. at a rate of 40° C./min, held at 250° C. for 5 min. The run time was 37.9 min. The carrier gas was Helium at 2.21 ml/min and the Flame ionization detector temperature was 270° C. whereas the injector temperature was 280° C. To enable maximal detector response, air, and hydrogen flows were adjusted. Peak identification was based on the relative retention times of two external standards. The area of each fatty acid peak was recorded using ChemStation software (Agilent Technologies) and the content of each individual fatty acid was defined as a percentage of total fatty acids within each sample. The results are tabulated in Table 5.

TABLE 5

| Treatment/ | | | |
|---|---|---|---|
| Fatty Acids % | SFA % | MUFA % | PUFA % |
| Raw turkey | 41.7 ± 0.7 | 32.8 ± 2.8 | 25.1 ± 3.4 |
| PF turkey | 41.5 ± 1.0 | 31.3 ± 0.6 | 27 ± 0.4 |
| MW turkey | 43.6 ± 1.8 | 31.5 ± 2.3 | 24.7 ± 0.3 |
| Raw entrecote | 54.1 ± 2.2 | 37.9 ± 2.1 | 7.7 ± 0.1 |
| PF entrecote | 52.4 ± 6.8 | 41.4 ± 4.6 | 6.2 ± 2.3 |
| MW entrecote | 48.0 ± 0.9 | 46.2 ± 3.1 | 6.1 ± 3.55 |

The results tabulated above indicate that in turkey, there was no change in the percentages of SFA, MUFA, and PUFA composition, between treatments and compared to raw turkey. As to entrecote meat, statistically significant differences were not observed. However, there was a trend that the SFA percentage was lower after MW treatment compared to PF and raw meat. The MUFA percentage increased after PF compared to raw and even more so after MW and on average, the PUFA percentage tended to be lower after PF compared to raw entrecote and decreased further in MW.

### Example 7

### Crust Preparation Method Amenable to Scaling-Up

Ground entrecote beef was divided into equal portions (5 g each), which were flattened to form 2.5 mm thick patties with the aid of an adjustable rolling pin equipped with silicon rings to determine the thickness required. The uniformly thick patties were fried using cast iron pan, Teflon-coated pan, and stainless-steel pan. The temperature of the pan was 260-270° C., 200° C. and 135-150° C., respectively. Frying time was up to 4 minutes, and the patties were flipped every one minute. Under these conditions, the patties turned in their entirety into crusts, weighing ~1.3 g each, thus achieving 90-100% yield on a dry basis (water content of entrecote beef is around 70%). The patties were ground to form powders.

### Example 8

### Suppressing Peroxidation of Soybean Oil with the Aid of Pan-Fried Entrecote Crusts Prepared on Different Surfaces

Crust obtained by frying ground beef patties (5 g each) on different types of pans was evaluated for its anti-lipid peroxidation activity by addition of 2 wt. % crust to 20 wt. soybean oil-based emulsion in water.

Treatments included crust prepared on stainless steel, cast iron, and Teflon pans by the procedure described in Example 7. A control group (treatment-free) and samples to which was added freeze dry fresh beef meat were also tested.

Lipid oxidation was induced by ferric chloride 10 μM with 100 μM ascorbic acid at 37° C. (incubation was performed at 37° C. for 1 h or 16 h). The ability of the crust to protect soybean oil from the pro-oxidant effect generated by the AA/iron pair was determined by measuring MDA levels in the samples through the TBARS reaction as described in the Examples above.

The results are presented graphically in the form of bar diagrams in FIG. 7, showing MDA concentrations expressed as nmol/ml emulsion (calculated from absorbance measurements at 532 nm as previously explained). The results show the strong antioxidant action of pan-fried crust formed on cast iron, stainless steel and Teflon made-surfaces, which effectively protected the oil from peroxidation by the AA/iron pair redox system. In contrast, freeze dry meat was found to generate prooxidant effect, showing higher MDA levels compared to the control (experiments were performed in triplicate; *P<0.05; bars from left to right: control, freeze-dried meat, cast-iron, Teflon and stainless steel fried crusts).

### Example 9

### Suppressing Peroxidation of Soybean Oil with the Aid of Crusts Obtained from Different Meats Fried on a Stainless Steel Pan

A series of experiments was performed based on the protocol described in Example 8. Crusts were prepared by frying beef (entrecote), turkey (breast), and chicken (breast) on stainless steel pan by the procedure described in Example 7. The crusts were ground into powders which were added to the 20% oil-in-water emulsion at a concentration of 0.5 wt. % and were tested for their ability to protect the oil against lipid peroxidation induced by the AA/iron pair.

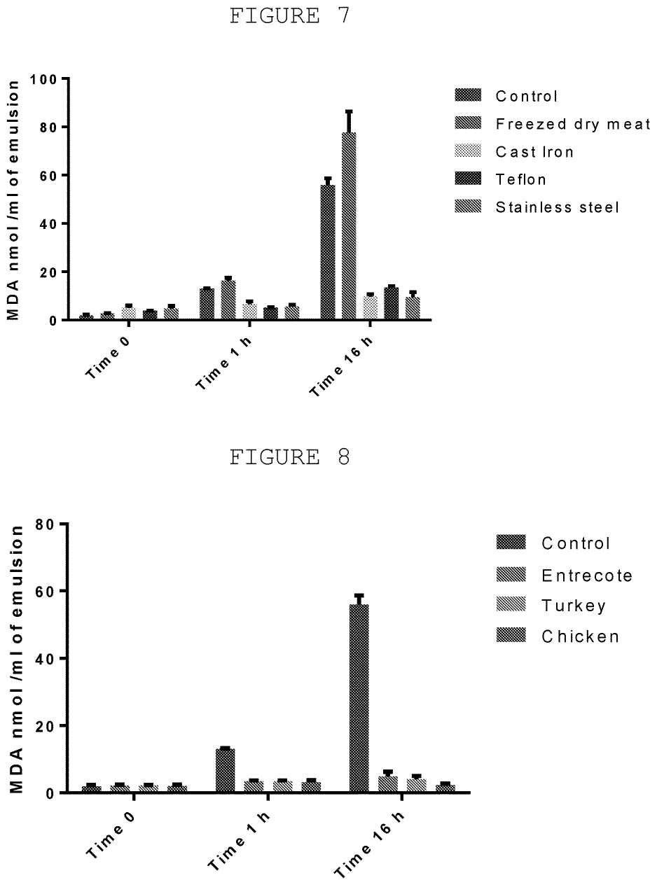

The results are shown in FIG. 8, with the ordinate indicating the MDA levels calculated from the absorbance measurements. All types of tested crusts showed a strong antioxidant (P<0.05 vs control with no crust; bars from left to right: control, entrecote, turkey and chicken).

### Example 10

### Suppressing Peroxidation of Soybean Oil with the Aid of Crusts Obtained from Different Meats Prepared on Different Surfaces

A series of experiments was performed based on the protocol described in the previous Example 8.

5 grams of ground low-cost meat mixture (consisting of various parts) and ground entrecote were flattened to a 2.5 mm thickness. The meats were fried either on a cast iron or Teflon® pan for a total of 4 minutes in 1-minute intervals per side and the crust created from frying was ground into powder. The emulsion system consisted of intra-lipid emulsion (0.5 ml), Ascorbic Acid (100 μM), iron chloride (10 μM), and water. 100 mg of the tested crust powder was incorporated into the emulsion system, and the rest of the crust powder was stored in either a vacuum bag (7 mbar) or a non-controlled conditions plastic bag. The control group used the emulsion system only. The emulsion and the crust were mixed and time 0 measurement was taken.

After 60 minutes of incubation at 37° Celsius, time 60 minutes was taken and 12% TCA was mixed immediately at a 1:1 ratio and centrifuged (Thermo Fisher, Heraeus Megafuge 16 R) for 10 min at 10,000 RPM at 4° C. Lipid peroxidation was determined by measuring TBA reactive substances (TBARS) which were expressed and calculated as malondialdehyde (MDA) levels. The supernatant after the centrifuge was mixed with TBA (10 mM) at a 1:1 ratio, and the samples were heated in a boiling water bath for 60 minutes. Then, the absorbance of the samples was measured at 532 nm (Shimadzu UV-1700, PharmaSpec), and the MDA was calculated according to 1 μmol/L=0.156 absorbance and expressed as nmol/ml of emulsion.

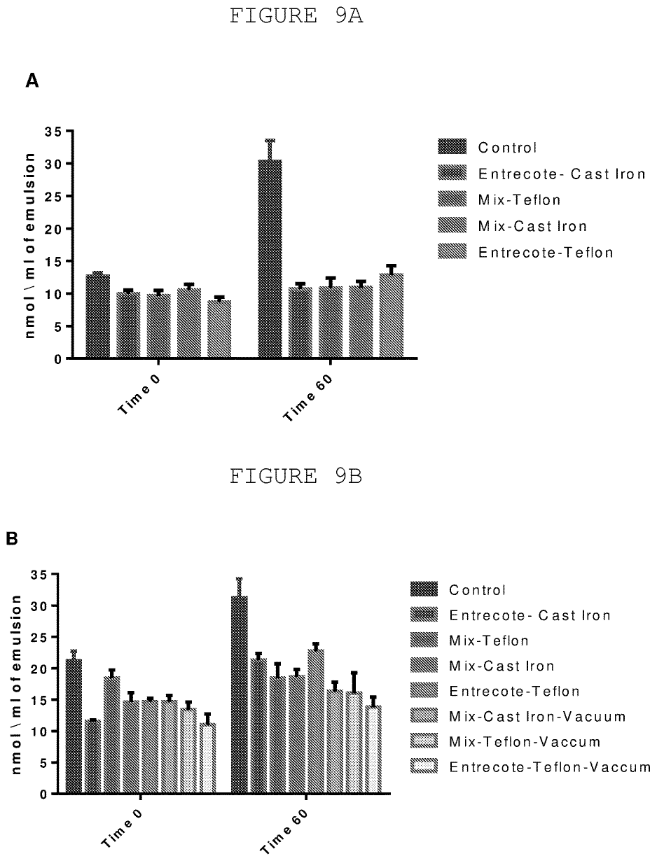

The results presented in FIGS. 9A and 9B show that crust powders produced from a variety of meats on different surfaces (cast iron, Teflon®) all provided good protection against peroxidation of the tested emulsion system.

### Example 11

### Suppressing Peroxidation in Frozen Hamburgers by Addition of a Pan-Fried Generated Entrecote Crust

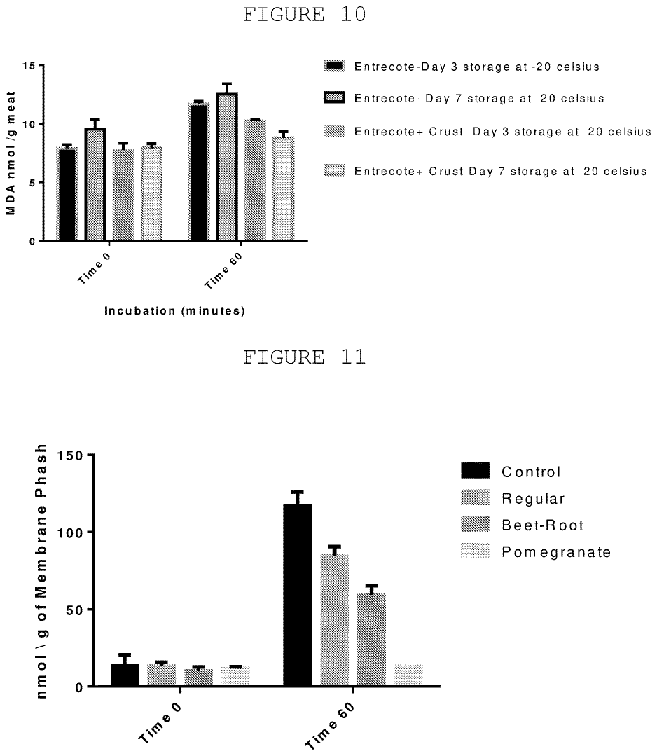

Antioxidant activity in frozen hamburgers was determined as follows. 2% crust prepared by cast iron pan by the procedure described in Example 7 was incorporated into the entrecote ground beef. Hamburgers were kept frozen in vacuum begs at 7 millibars at −20° C. for three- or seven-days storage period (the control group consisted of crust-free hamburgers). Hamburgers were then prepared by Ninja grill and levels of MDA were evaluated from three different places in the patty by the methodology described above. Results are shown in FIG. 10 (bars order: left to right).

### Example 12

Suppressing peroxidation in turkey membrane phase by addition of a marinated pan-fried generated entrecote crust Marinated crust samples were prepared as follows. Five grams of ground entrecote meat was immersed either in water, pomegranate heat-inactivated juice, or beetroot heat-inactivated juice for 5 seconds and was left to dry for 30 minutes. Then marinated meat were flattened into 2.5 mm thick patties which were fried on a cast iron pan for 1.5 minutes per side. The crust was separated and ground into a powder.

The tested crust powder (100 mg) was added to the wash turkey meat system comprising 500 mg of turkey's membrane phase prepared as previously described, Ascorbic Acid (100 μM), ferric chloride (10 μM) in water (water was added to 5 ml). The control was without the crust. After 60 minutes of incubation, 12% TCA was mixed immediately at a 1:1 ratio and centrifuged (Thermo Fisher, Heraeus Megafuge 16 R) for 10 min at 10,000 RPM at 4° C. Lipid peroxidation was determined by measuring TBA reactive substances (TBARS) which were expressed and calculated as malondialdehyde (MDA) levels. The supernatant after the centrifuge was mixed with TBA (10 mM) at a 1:1 ratio, and the samples were heated in a boiling water bath for 15 min. Then, the absorbance of the samples was measured at 532 nm (Shimadzu UV-1700, PharmaSpec), and the MDA was calculated according to 1 μmol/L=0.156 absorbance and expressed as nmol/g membrane phase.

The results are shown in the form of a bar diagram in FIG. 11, indicating that crust powder obtained from pomegranate or beetroot-marinated meat is a potent antioxidant restraining peroxidation in meat products in an effective manner effectively (experiments performed in triplicate).

### Example 13

### Characterization of the Composition of Meat-Derived Crusts

### Part A: Water Content

Water content of crust samples derived from beef and chicken by frying on cast iron pan by the procedure described in Example 7, was determined. The crust powder was added to a preweighed test tube which was then weighed again and placed for 3.5 minutes in a microwave oven (Dow, South Korea, at 800 W). Water loss was calculated as tabulated below.

TABLE 6

| | | | Post-microwave | |
|---|---|---|---|---|
| | tube | tube + crust | oven Tube + | Water |
| | weight (g) | weight (g) | crust weight | content % |
| beef crust 1 | 3.165 | 3.25 | 3.25 | 0 |
| beef crust 2 | 3.109 | 3.27 | 3.26 | 6.2 |
| beef crust 3 | 3.128 | 3.27 | 3.27 | 0 |
| chicken crust 1 | 3.137 | 3.26 | 3.25 | 8.1 |
| Chicken crust 2 | 3.179 | 3.28 | 3.27 | 0.4 |
| Chicken crust 3 | 3.152 | 3.3 | 3.3 | 0 |

### Part B: Elemental Analysis

Powders of entrecote crust prepared in iron and stainless-steel pans (as described in Example 7) were tested. Three batches of the powder, a few mg each, were weighed with a Sartorius microbalance to the nearest 1 μg and analyzed with a Thermo Flash EA-1112 Elemental analyzer. The instrument was calibrated with special standards to determine the C, N, H, O, and S content. The results (average and standard deviation) are tabulated below.

TABLE 7

| | N (%) | C (%) | H (%) | O (%) | S (mg/kg) |
|---|---|---|---|---|---|
| Crust prepared in | 13.56 | 54.67 | 9.6 | 22.30 | 7375.8 |
| iron cast pan | 0.21 | 0.56 | 0.16 | 0.93 | 280 |
| Crust prepared in | 13.18 | 53.54 | 9.23 | 23.34 | 7587.18 |
| stainless-steel pan | 0.40 | 0.57 | 1.85 | 1.27 | 58.13 |

N, C, H, O and S contents in crust powders of the invention were comparable to those measured in freeze-dried entrecote meat, i.e., the raw material from which the crusts were produced.

1. A process for preparing a meat-derived antioxidant, comprising cooking or heat drying meat by direct contact with a hot surface to form a crust and comminuting an isolated form of the crust to obtain crust particles suitable for use as a food additive.

2. The process according to claim 1, comprising cooking or heat drying beef, chicken, and/or turkey meat to form the crust.

3. The process according to claim 1, comprising transferring heat to the meat solely by thermal conduction from a hot surface made of cast iron, stainless steel, anodized aluminum, and/or polytetrafluoroethylene-coated surface.

4. The process according to claim 1, comprising placing meat on a heated iron surface for a short duration of time, sufficient to produce crust, isolating the formed crust and crushing it.

5. The process according to claim 1, comprising pan-frying meat in a flattened form to create the crust, separating the crust from the bulk meat, and comminuting the crust to form a powder.

6. The process according to claim 1, comprising pan-frying meat in a flattened form at thickness lower than 5 mm to convert the entire mass into crust, and comminuting the crust.

7. The process according to claim 1, comprising drum drying a thin layer of meat in contact with the outer surfaces of a pair of adjacent, internally heated, revolving drums, following which a dried film or powder is collected.

8. The process according to claim 4, wherein the meat comprises a ground beef, turkey or chicken meat in a flattened form.

9. The process according to claim 1, comprising cooking or heat-drying a marinated meat obtained by soaking the meet in a plant-based liquid.

10. The process according claim 9, wherein the meat was previously soaked in a pomegranate marinade or a beetroot marinade.

11. A food antioxidant comprising a comminuted form of a meat crust obtainable, or obtained by, thermal conduction.

12. The food antioxidant according to claim 11, obtainable by a process for preparing a meat-derived antioxidant, comprising cooking or heat drying meat by direct contact with a hot surface to form a crust and comminuting an isolated form of the crust to obtain crust particles suitable for use as a food additive and transferring heat to the meat solely by thermal conduction from the hot surface made of cast iron, stainless steel, anodized aluminum, and polytetrafluoroethylene-coated surface.

13. The food antioxidant according to claim 11, obtained by a process for preparing a meat-derived antioxidant, comprising cooking or heat drying meat by direct contact with a hot surface to form a crust and comminuting an isolated form of the crust to obtain crust particles suitable for use as a food additive and transferring heat to the meat solely by thermal conduction from the hot surface made of cast iron, stainless steel, anodized aluminum, and/or polytetrafluoroethylene-coated surface.

14. The food antioxidant according to claim 11, which is an isolated pan-fried meat crust in a powder form.

15. A food antioxidant for restraining oxidation of food products, comprising meat crust in a comminuted form, with typical brown or dark brown color, showing at least one of the following characteristics:
A) water content of less than 10 wt. %;
B) Maillard Reaction products indicated by
B1) protein carbonylation level of not less than 40 nmol of protein carbonyls per 1 mg protein, as measured by reacting the crust with 2,4-dinitrophenylhydrazine (DNPH) to form hydrazone; and/or
B2) advanced glycation end products of not less than 20 ng per 1 μg protein;
C) 100 mg of crust reduces at least 10 micromolar of Fe³⁺, as measured by the Ferene colorimetric assay; and
D) elemental analysis (C, N, H, O, S) essentially comparable to elemental analysis of a corresponding raw meat.

16. The food antioxidant according to claim 15 in a powder form having the following combination of characteristics:
A) water content of less than 7.0 wt. %;
B) Maillard reaction products indicated by
B1) protein carbonylation level of not less than 50 nmol of protein carbonyls per 1 mg protein;
C) 100 mg of crust reduces at least 10 micromolar of Fe³⁺, as measured by the Ferene colorimetric assay; and
D) elemental analysis (C, N, H, O, S) essentially comparable to elemental analysis of a corresponding raw meat.

17. The food product comprising the food antioxidant of claim 11.

18. The food product according to claim 17, which is a frozen beef meat patty.

19. The food product according to claim 17, which is a food emulsion.

20. A method for lowering peroxidation of a food product comprising adding to said food product the food antioxidant of claim 11.

21. (canceled)
